(19) United States
(12) Patent Application Publication
(10) Pub. No.: US 2024/0342661 A1
(43) Pub. Date: Oct. 17, 2024

(54) RECYCLABLE ELECTRET FILTERING MEMBRANE, PREPARATION METHOD THEREFOR AND CLEANING AND CHARGE REGENERATION METHOD THEREFOR

(71) Applicant: SOUTH CHINA UNIVERSITY OF TECHNOLOGY, Guangzhou (CN)

(72) Inventors: Rongrong CAI, Guangzhou (CN); Jiusi WANG, Guangzhou (CN); Lizhi ZHANG, Guangzhou (CN)

(73) Assignee: SOUTH CHINA UNIVERSITY OF TECHNOLOGY, Guangzhou (CN)

(21) Appl. No.: 18/754,201

(22) Filed: Jun. 26, 2024

Related U.S. Application Data
(63) Continuation of application No. PCT/CN2022/128473, filed on Oct. 31, 2022.

(30) Foreign Application Priority Data
Jan. 24, 2022 (CN) 202210082584.6

(51) Int. Cl. B01D 69/08; B01D 46/00; B01D 46/54; B01D 46/66; B01D 53/22; B01D 65/02; B01D 67/00; B01D 71/36; B01D 71/80

(52) U.S. Cl. CPC B01D 69/087; B01D 46/0032; B01D 46/543; B01D 46/785; B01D 53/228; B01D 65/02; B01D 67/0083; B01D 67/0095; B01D 69/081; B01D 71/36; B01D 71/80; B01D 2321/22; B01D 2323/081; B01D 2323/12; B01D 2323/35; B01D 2323/39

(57) ABSTRACT

Provided are a recyclable electret filtering membrane, a preparation method therefor and a cleaning and charge regeneration method therefor. The preparation method includes: dissolving fluorine-containing polymer particles and polyoxyethylene particles in deionized water to prepare a spinning solution, and then performing electrostatic spinning, calcining, cooling, drying and corona charging to obtain the recyclable electret filtering membrane. A surface of the filtering membrane is subjected to water drop rolling cleaning and friction electrification after dust holding, and then dried to realize charge regeneration and reuse. The filtering membrane obtained in the present invention has an initial surface potential of (−600)-(−950) V, the potential can be regenerated to (−700)-(−1000) V by water drop rolling and electrification after dust holding, the charge recovery rate is 90%-125%, the dust removal rate is 90%-100%, and the filtering efficiency for PM_{2.5} is equal to or greater than 94%.

### CROSS-REFERENCE TO RELATED APPLICATION

This application is a continuation of international application of PCT application serial no. PCT/CN2022/128473, filed on Oct. 31, 2022, which claims the priority benefit of China application no. 202210082584.6, filed on Jan. 24, 2022. The entirety of each of the above mentioned patent applications is hereby incorporated by reference herein and made a part of this specification.

### TECHNICAL FIELD

The present invention relates to the technical field of air purification and indoor air quality, and specifically relates to a recyclable electret filtering membrane, a preparation method therefor and a cleaning and charge regeneration method therefor.

### RELATED ART

Fine particulate matter (PM_{2.5}) pollution causes serious harm to human health, public health and precision manufacturing. A technology for filtering particulate matter using a porous medium is considered as a most effective air purification technology that is beneficial to health.

As a core of air filtration equipment, a porous PM_{2.5} filtering material has constantly increased filtration resistance and operation energy consumption with deposition of particles during use, and even causes secondary air pollution, which needs to be replaced regularly. Dust removal, regeneration and recycling of the filtering material are extremely important to reduce energy consumption in filtration and realize environmental protection.

An electret filtering material can store electrostatic charges for a long time, have an additional electrostatic trapping effect, and can improve filtering efficiency without increasing filtration resistance, thus having been widely used. Due to inherent charge dissipation, the electret filtering material has the problems of effective dust removal and charge regeneration, which need to be solved simultaneously so as to realize cyclic regeneration.

According to a Chinese invention patent with publication No. CN105920919A disclosed on Sep. 7, 2016, a method for preparation and activation a super-hydrophobic electret filter material for purifying PM_{2.5} is disclosed. The method includes: placing a filtered filter material in a high-voltage electric field, and then performing backflush and corona recharging to regenerate the electret so as to realize reuse.

The above technology has the disadvantages that it is difficult for gas flushing to

effectively remove deposited particles; and high-voltage corona recharging is used for electret in an activation process, which has complicated operation and may produce ozone.

According to a Chinese utility model patent with publication No. CN212650438U disclosed on Mar. 5, 2021, a regeneration device for a virus filtering mask is disclosed, and a direct current high-voltage electrostatic generator is designed to convert power frequency alternating current or direct current into direct current high-voltage static electricity, which is used for recharging an electret filter material and assisting in killing viruses.

The above technology has the disadvantages that charges are regenerated by charging using a high-voltage electric field each time, which has complicated operation is and prone to produce ozone; and unable to remove captured particles, so that the technology is not suitable for regeneration of general industrial or indoor electret filters.

### SUMMARY OF INVENTION

### Solution to Problem

In order to overcome the above defects and disadvantages of the prior art, the purpose of the present invention is to provide a recyclable electret filtering membrane, a preparation method therefor and a cleaning and charge regeneration method therefor. An electrostatic spinning fiber membrane with a surface containing C—F bond, prepared by the present invention, can carry away deposited particles by water drop rolling, and water drops undergo friction electrification with the surface of the filtering membrane during rolling, so as to realize dust removal, charge regeneration and recycling of the electret filtering membrane.

The purpose of the present invention is realized by adopting the following technical schemes.

A preparation method for a recyclable electret filtering membrane includes the following steps: dissolving fluorine-containing polymer particles and polyoxyethylene particles in deionized water to prepare a spinning solution, and performing electrostatic spinning for the spinning solution to obtain a fiber membrane, performing calcining, cooling and drying for the fiber membrane to obtain a porous fiber membrane, and subsequently performing corona charging for the porous fiber membrane to obtain the recyclable electret filtering membrane.

Preferably, the fluorine-containing polymer particles include one or more of polytetrafluoroethylene and a perfluoroethylene propylene copolymer.

Preferably, the mass ratio of the fluorine-containing polymer particles to the polyoxyethylene particles ranges from 15:1 to 25:1.

Preferably, the mass fraction of polyoxyethylene in the spinning solution is 3%-7%.

Preferably, the calcining is performed at a temperature of 350° C.-400° C. for 5 min-10 min; and the calcining is performed in an air atmosphere.

Preferably, the corona charging is performed under the following charging conditions: the voltage is −10 kV to −15 kV, the distance between a needle and a ground plate is 3 cm-5 cm, and the charging time is 5 min-10 min.

Preferably, the electrostatic spinning is performed at a spinning voltage of 15 kV-25 kV,

an injection speed of 0.06 mm/min-0.12 mm/min, a roller speed of 80 r/min-120 r/min, and an ambient relative humidity of 40% RH-60% RH.

Preferably, the recyclable electret filtering membrane further includes further fluorination improvement; and a substance used for the fluorination improvement includes one or more of perfluorooctyltriethoxysilane and perfluorodecyltriethoxysilane.

Further preferably, the fluorination improvement specifically includes: performing surface fluorination by dip coating; and a dip-coated surface fluorination solution has a mass fraction of 2%-5%.

According to the recyclable electret filtering membrane prepared by the preparation method, the recyclable electret filtering membrane is an electrostatic spinning fiber membrane with a surface containing a C—F bond.

Preferably, the recyclable electret filtering membrane has a fiber diameter of 1 μm-15 μm, a gram weight of 50 g/m²-150 g/m², a water contact angle of 140°-160°, an initial surface potential of −600 V to −950 V, and an initial pressure drop of 60 Pa-150 Pa; and after cleaning and regeneration, the potential is regenerated to −700 V to −1000 V, the charge recovery rate is 90%-125%, the dust removal rate is 90%-100%, and the filtering efficiency for PM_{2.5} is equal to or greater than 94%.

A cleaning and charge regeneration method for the recyclable electret filtering membrane includes the following steps: subjecting a surface of the recyclable electret filtering membrane to water drop rolling cleaning and friction electrification after dust holding, and then performing drying to realize charge regeneration and reuse.

Preferably, the cleaning and charge regeneration method specifically includes: (1) fixing the electret filtering membrane to a platform with adjustable height and inclination angle after dust holding;

(2) controlling the inclination angle of the filtering membrane and the volume, dropping height, dropping time interval and total dropping time of a single water drop, and subjecting the dust-held filtering membrane to water drop rolling cleaning and friction electrification; and

(3) drying the cleaned filtering membrane.

Preferably, a method for the water drop rolling cleaning and friction electrification is as follows: the inclination angle of the recyclable electret filtering membrane is 30°-60°; water drops drop continuously and roll down from the surface of the filtering membrane, the volume of a single water drop is 10 μL-100 μL, the dropping height is 3 cm-10 cm, the dropping time interval is 1 s-10 s, and the total dropping time is 5 min-15 min; and the drying is performed at a temperature of 40° C.-60° C.

### Effects of Invention

Compared with the prior art, the present invention has the following advantages and beneficial effects.

(1) In the present invention, a water drop rolling contact and electrification method is used for the first time to realize charge regeneration of the electret filtering membrane, and electrostatic filtering efficiency of the electret filtering membrane is restored. During rolling friction between water drops and the filtering membrane with a surface containing a C—F bond, the C—F bond is destroyed and an electron defect structure is generated, such that LUMO on the surface of the fluorine-containing fiber filtering membrane attracts a large number of external electrons to produce stable surface potential.

(2) The water contact angle of the surface of the electret filtering membrane in the present invention can reach 157°. By means of a superhydrophobic property of the surface of the filtering membrane, deposited particles on the surface of the filtering membrane are cleaned by a water drop rolling method to realize dust removal and regeneration, and good recyclability is achieved.

### BRIEF DESCRIPTION OF DRAWINGS

FIG. 1a is an electron micrograph of a composite filtering membrane obtained by blending of polytetrafluoroethylene and polyoxyethylene in Example 1.

FIG. 1b is an electron micrograph of a polytetrafluoroethylene filtering membrane obtained after calcining in Example 1.

FIG. 2a is an EDS diagram of the composite filtering membrane obtained by blending of polytetrafluoroethylene and polyoxyethylene in Example 1.

FIG. 2b is an EDS diagram of the polytetrafluoroethylene filtering membrane obtained after calcining in Example 1.

FIG. 3 is a schematic diagram of a water drop rolling cleaning and friction electrification device of the present invention.

FIG. 4 is a variation diagram of the surface potential in a cyclic process of dust holding, filtration, dust removal and regeneration for three times in Examples 1, 2, 3 and 4.

### DESCRIPTION OF EMBODIMENTS

The present invention is further described in detail below in combination with examples and attached drawings, but the embodiments of the present invention are not limited thereto.

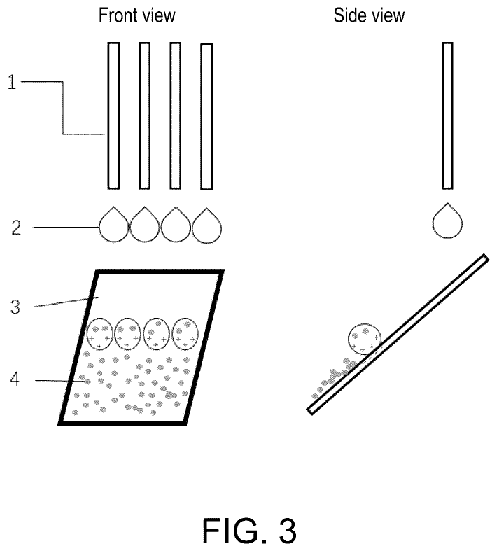

A schematic diagram of a water drop rolling cleaning and friction electrification device of the present invention is shown in FIG. 3. 1 refers to water pipes, where water drops can cover the entire surface of the filtering membrane by using four water pipes in the device, and the dropping height can be adjusted. 2 refers to water drops, where the volume, dropping time interval and total dropping time of the water drops can be adjusted. 3 refers to a dust-held electret filtering membrane, where the inclination angle of the filtering membrane can be adjusted. 4 refers to dust particles on the surface of the dust-held filtering membrane, where the particles can be carried away by rolling of the water drops to achieve dust removal and regeneration.

### EXAMPLE 1

(1) 9 g of polytetrafluoroethylene, 0.2 g of polyoxyethylene and 8.7 g of deionized water were accurately weighed by a balance scale and placed into a 50 mL beaker, then stirring bars were added, and a resulting mixture was stirred on a magnetic stirrer for 36 h to obtain a uniform and stable spinning solution.

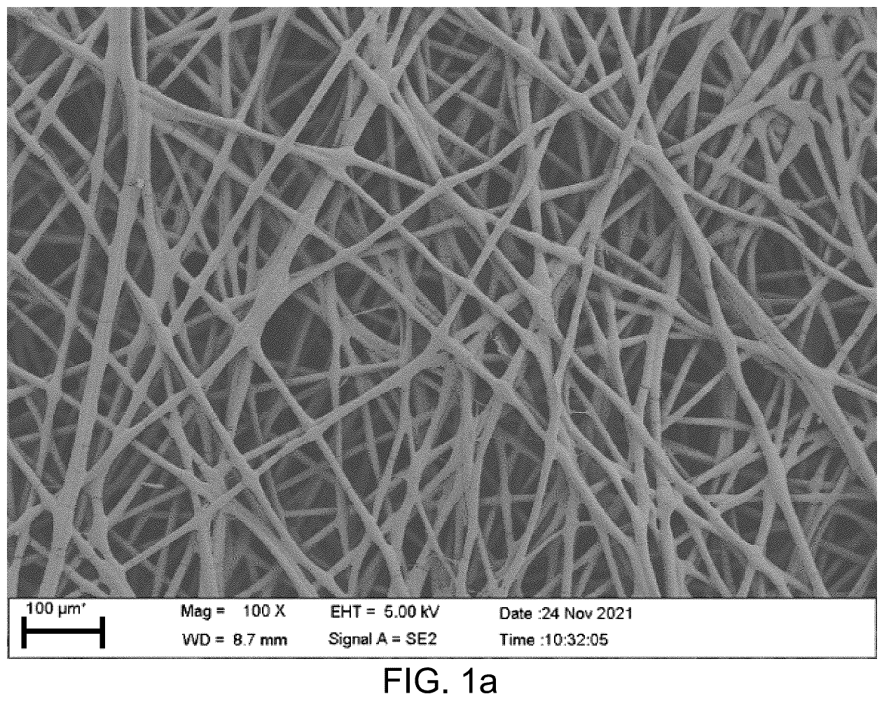

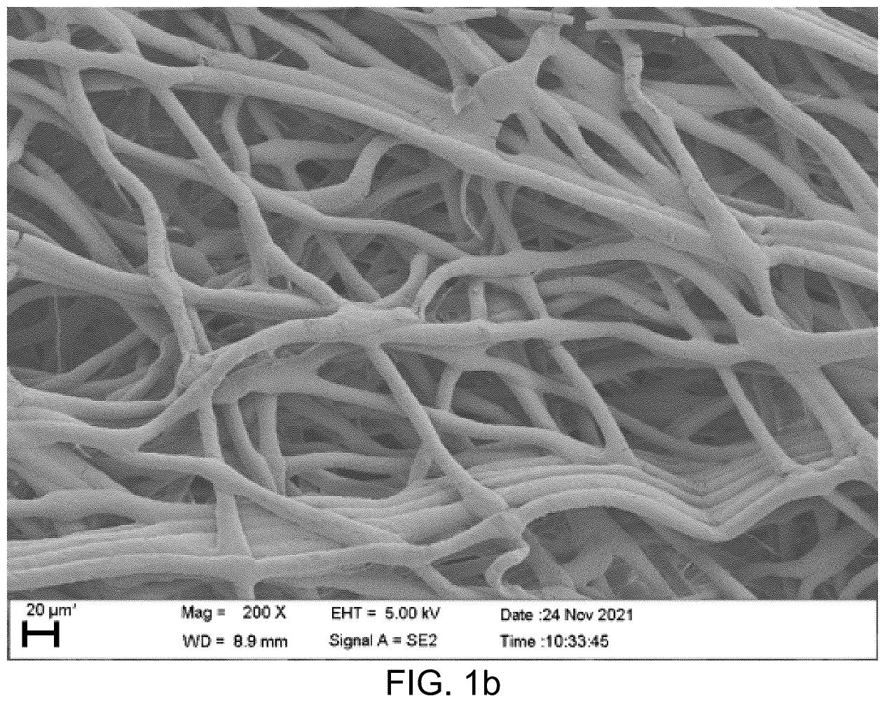

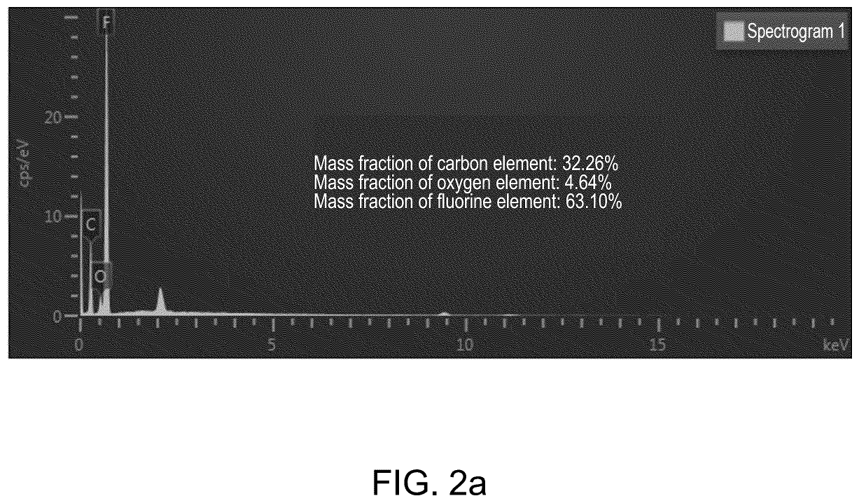

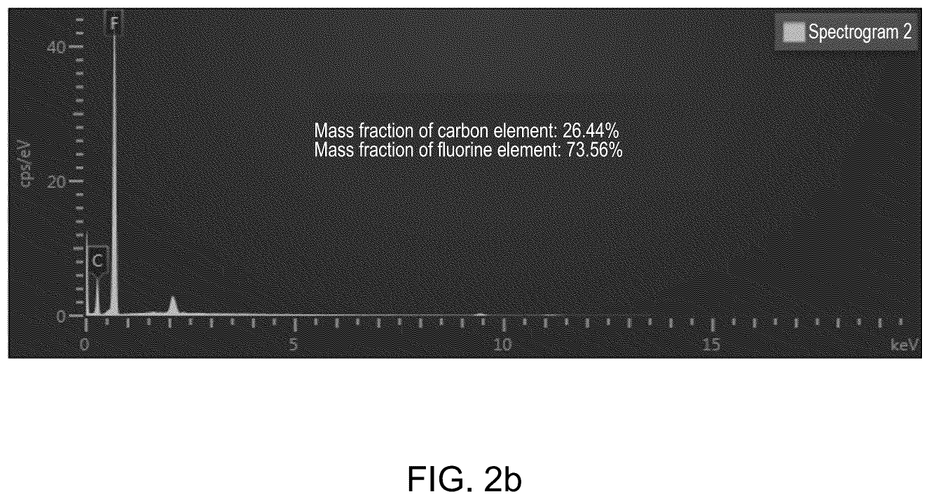

(2) Spinning parameters were set as follows: the spinning voltage was 18 kV, the injection speed was 0.06 mm/min, the roller speed was 120 r/min, and the ambient relative humidity was 60% RH. Electrostatic spinning was performed with the spinning solution to prepare a polytetrafluoroethylene/polyoxyethylene composite filtering membrane, as shown in FIG. 1a and FIG. 2a.

(3) The prepared composite filtering membrane was dried at room temperature for 4 h, and then calcined at a temperature of 390° C. for 10 min to obtain a polytetrafluoroethylene filtering membrane, as shown in FIG. 1b and FIG. 2b. Before the calcining, the mass fraction of oxygen element was 4.64% due to the presence of polyoxyethylene, and after the calcining, the oxygen element was not contained in the filtering membrane since the polyoxyethylene was removed.

(4) The polytetrafluoroethylene filtering membrane was subjected to corona charging to obtain a polytetrafluoroethylene electret filtering membrane, where the voltage was −10 kV, the distance between a needle and a ground plate was 3 cm, and the charging time was 10 min.

(5) The polytetrafluoroethylene electret filtering membrane was subjected to dust holding and filtration for 120 min, where dust holding particles were sodium chloride, and the dust holding capacity was 1.6 g/m².

(6) The dust-held polytetrafluoroethylene filtering membrane was subjected to cleaning and charge regeneration by a water drop rolling cleaning and rolling friction electrification device, as shown in FIG. 3. A total of four streams of water were dropped onto the surface of the filtering membrane simultaneously, the inclination angle of the filtering membrane was 60°, the volume of a single water drop was 10 μL, the dropping height of water drops was 3 cm, the dropping time interval of the water drops was 1 s, and the total dropping time was 5 min. Then, the polytetrafluoroethylene filtering membrane was dried at 60° C. for 1 h. (7) Steps (5) and (6) were repeated to carry out a cyclic experiment for three times.

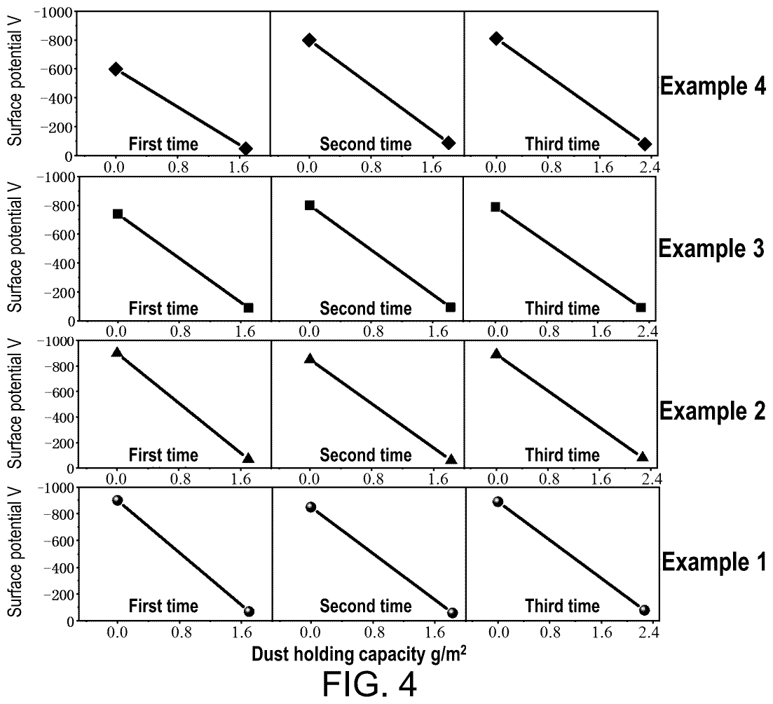

The polytetrafluoroethylene electret filtering membrane obtained in this example had a fiber diameter of 10 μm, a water contact angle of 140°, a gram weight of 71.2 g/m², an initial potential of −740 V, an initial pressure drop of 64 Pa, and an initial filtering efficiency of 95.30% for PM_{2.5}. As shown in FIG. 4, the surface potential of the polytetrafluoroethylene filtering membrane can be regenerated to −800 V or above by water drop rolling and friction electrification, the pressure drop can be restored to 81 Pa by water drop rolling cleaning, and the filtering efficiency for PM2.5 is maintained at 95.1% or above.

### EXAMPLE 2

(1) 10.8 g of a perfluoroethylene propylene copolymer, 0.2 g of polyoxyethylene and 2 g of deionized water were accurately weighed by a balance scale and placed into a 50 mL beaker, then stirring bars were added, and a resulting mixture was stirred on a magnetic stirrer for 36 h to obtain a uniform and stable spinning solution.

(2) Spinning parameters were set as follows: the spinning voltage was 21 kV, the injection speed was 0.06 mm/min, the roller speed was 80 r/min, and the ambient relative humidity was 60% RH. Electrostatic spinning was performed with the spinning solution to prepare a perfluoroethylene propylene copolymer/polyoxyethylene composite filtering membrane. (3) The prepared composite filtering membrane was dried at room temperature for 4 h,

and then calcined at a temperature of 300° C. for 10 min to obtain a perfluoroethylene propylene copolymer filtering membrane.

(4) The perfluoroethylene propylene copolymer filtering membrane was subjected to corona charging to obtain a perfluoroethylene propylene copolymer electret filtering membrane, where the voltage was −10 kV, the distance between a needle and a ground plate was 3 cm, and the charging time was 10 min.

(5) The perfluoroethylene propylene copolymer electret filtering membrane was subjected to dust holding and filtration for 120 min, where dust holding particles were sodium chloride, and the dust holding capacity was 1.7 g/m².

(6) The dust-held perfluoroethylene propylene copolymer filtering membrane was subjected to cleaning and charge regeneration by a water drop rolling cleaning and rolling friction electrification device, as shown in FIG. 3. A total of four streams of water were dropped onto the surface of the filtering membrane simultaneously, the inclination angle of the filtering membrane was 45°, the volume of a single water drop was 50 μL, the dropping height of water drops was 3 cm, the dropping time interval of the water drops was 3 s, and the total dropping time was 5 min. Then, the perfluoroethylene propylene copolymer filtering membrane was dried at 60° C. for 1 h.

The perfluoroethylene propylene copolymer electret filtering membrane obtained in this example had a fiber diameter of 8 um, a water contact angle of 140°, a gram weight of 90.3 g/m2, an initial potential of −900 V, an initial pressure drop of 71 Pa, and an initial filtering efficiency of 96.3% for PM_{2.5}. As shown in FIG. 4, the surface potential of the perfluoroethylene propylene copolymer filtering membrane can be regenerated to −850 V or above by water drop rolling and friction electrification, the pressure drop can be restored to 83 Pa by water drop rolling cleaning, and the filtering efficiency for PM_{2.5} is maintained at 94.2% or above.

### EXAMPLE 3

(1) A polytetrafluoroethylene fiber filtering membrane was prepared by the steps (1) to (3) in Example 1.

(2) 0.1 g of silica nanoparticles and 30 ml of n-hexane were mixed to prepare silica suspended water (named as \textcircled{1}), 1 g of Dow Corning 184 polydimethylsiloxane (mixed with a supporting curing agent at 10:1) and 10 g of n-hexane were mixed to prepare an adhesive (named as (\textcircled{2}), 1 ml of a \textcircled{2} aqueous solution was added into a \textcircled{1} aqueous solution to obtain a new aqueous solution (named as \textcircled{3}), and 0.5 g of perfluorodecyltriethoxysilane, 24.375 g of n-hexane and 0.125 g of acetic acid were mixed to obtain a fluorosilane solution (named as \textcircled{4}). The prepared polytetrafluoroethylene fiber filtering membrane was soaked in the \textcircled{3} solution for 30 min and dried at 60° C. for 1 h, and the operations were repeated for three times. Then, the membrane was soaked in the \textcircled{4} aqueous solution for 30 min and dried at 60° C. for 1 h, and the operations were repeated for three times. Finally, a surface fluorination modified polytetrafluoroethylene electret filtering membrane was prepared.

(3) The surface fluorination modified polytetrafluoroethylene filtering membrane prepared in step (2) was subjected to corona charging to obtain a surface fluorination modified polytetrafluoroethylene electret filtering membrane, where the voltage was −10 kV, the distance between a needle and a ground plate was 3 cm, and the charging time was 10 min.

(4) The surface fluorination modified polytetrafluoroethylene electret filtering membrane was subjected to dust holding and filtration for 120 min, where dust holding particles were sodium chloride, and the dust holding capacity was 1.6 g/m².

(5) The dust-held surface fluorination modified polytetrafluoroethylene electret filtering membrane was subjected to cleaning and charge regeneration by a water drop rolling cleaning and rolling friction electrification device, as shown in FIG. 3. A total of four streams of water were dropped onto the surface of the filtering membrane simultaneously, the inclination angle of the filtering membrane was 45°, the volume of a single water drop was 100 μL, the dropping height of water drops was 5 cm, the dropping time interval of the water drops was 2 s, and the total dropping time was 10 min. Then, the surface fluorination modified polytetrafluoroethylene electret filtering membrane was dried at 60° C. for 1 h.

(6) Steps (4) and (5) were repeated to carry out a cyclic experiment for a total of three times.

The surface fluorination modified polytetrafluoroethylene electret filtering membrane obtained in this example had a fiber diameter of 11 μm, a water contact angle of 157°, a gram weight of 101.2 g/m², an initial potential of −764 V, an initial pressure drop of 129 Pa, and an initial filtering efficiency of 97.2% for PM_{2.5}. As shown in FIG. 4, the surface potential of the surface fluorination modified polytetrafluoroethylene electret filtering membrane can be regenerated to −701 V or above by water drop rolling and friction electrification, the pressure drop can be restored to 131 Pa by water drop rolling cleaning, and the filtering efficiency for PM2.5 is maintained at 96.7% or above.

### EXAMPLE 4

(1) A perfluoroethylene propylene copolymer fiber filtering membrane was prepared by the steps (1) to (3) in Example 1.

(2) 0.1 g of silica nanoparticles and 30 ml of n-hexane were mixed to prepare silica suspended water (named as \textcircled{1}), 1 g of Dow Corning 184 polydimethylsiloxane (mixed with a supporting curing agent at 10:1) and 10 g of n-hexane were mixed to prepare an adhesive (named as \textcircled{2}), 1 ml of a \textcircled{2} aqueous solution was added into a \textcircled{1} aqueous solution to obtain a new aqueous solution (named as \textcircled{3}), and 0.7 g of perfluorooctyltriethoxysilane, 21.155 g of n-hexane and 0.145 g of acetic acid were mixed to obtain a fluorosilane solution (named as \textcircled{4}). The prepared perfluoroethylene propylene copolymer fiber filtering membrane was soaked in the \textcircled{3} solution for 30 min and dried at 60° C. for 1 h, and the operations were repeated for three times. Then, the membrane was soaked in the \textcircled{4} aqueous solution for 30 min and dried at 60° C. for 1 h, and the operations were repeated for three times. Finally, a surface fluorination modified perfluoroethylene propylene copolymer electret filtering membrane was prepared.

(3) The surface fluorination modified perfluoroethylene propylene copolymer filtering membrane prepared in step (2) was subjected to corona charging to obtain a surface fluorination modified perfluoroethylene propylene copolymer electret filtering membrane, where the voltage was −10 kV, the distance between a needle and a ground plate was 3 cm, and the charging time was 10 min.

(4) The surface fluorination modified perfluoroethylene propylene copolymer electret filtering membrane was subjected to dust holding and filtration for 120 min, where dust holding particles were sodium chloride, and the dust holding capacity was 1.6 g/m².

(5) The dust-held surface fluorination modified perfluoroethylene propylene copolymer electret filtering membrane was subjected to cleaning and charge regeneration by a water drop rolling cleaning and rolling friction electrification device, as shown in FIG. 3. A total of four streams of water were dropped onto the surface of the filtering membrane simultaneously, the inclination angle of the filtering membrane was 30°, the volume of a single water drop was 100 μL, the dropping height of water drops was 10 cm, the dropping time interval of the water drops was 10 s, and the total dropping time was 15 min. Then, the surface fluorination modified perfluoroethylene propylene copolymer electret filtering membrane was dried at 60° C. for 1 h.

(6) Steps (4) and (5) were repeated to carry out a cyclic experiment for a total of three times.

The surface fluorination modified perfluoroethylene propylene copolymer electret filtering membrane obtained in this example had a fiber diameter of 10 μm, a water contact angle of 153°, a gram weight of 120.1 g/m², an initial potential of −650 V, an initial pressure drop of 110 Pa, and an initial filtering efficiency of 95.1% for PM_{2.5}. As shown in FIG. 4, the surface potential of the surface fluorination modified perfluoroethylene propylene copolymer electret filtering membrane can be regenerated to −800 V or above by water drop rolling and friction electrification, the pressure drop can be restored to 121 Pa by water drop rolling cleaning, and the filtering efficiency for PM_{2.5} is maintained at 97.7% or above.

The above examples are preferred embodiments of the present invention, but the embodiments of the present invention are not limited by the above examples. Any other changes, modifications, substitutions, combinations and simplifications that are made without departing from the spiritual essence and principles of the present invention shall be regarded as equivalent replacement modes, and are included in the scope of protection of the present invention.

What is claimed is:

1. A preparation method for a recyclable electret filtering membrane, comprising following steps: dissolving fluorine-containing polymer particles and polyoxyethylene particles in deionized water to prepare a spinning solution, and performing electrostatic spinning for the spinning solution to obtain a fiber membrane, performing calcining, cooling and drying for the fiber membrane to obtain a porous fiber membrane, and subsequently performing corona charging for the porous fiber membrane to obtain the recyclable electret filtering membrane.

2. The preparation method for the recyclable electret filtering membrane according to claim 1, wherein the fluorine-containing polymer particles comprise one or more of polytetrafluoroethylene and a perfluoroethylene propylene copolymer; mass ratio of the fluorine-containing polymer particles to the polyoxyethylene particles ranges from 15:1 to 25:1; and mass fraction of polyoxyethylene in the spinning solution ranges from 3%-7%.

3. The preparation method for the recyclable electret filtering membrane according to claim 1, wherein the calcining is performed at a temperature of 350° C.-400° C. for 5 min-10 min;
and the corona charging is performed under following charging conditions: a voltage is (−10)-(−15) kV, a distance between a needle and a ground plate is 3 cm-5 cm, and a charging time is 5 min-10 min.

4. The preparation method for the recyclable electret filtering membrane according to claim 1, wherein the electrostatic spinning is performed at a spinning voltage of 15-25 kV, an injection speed of 0.06 mm/min-0.12 mm/min, a roller speed of 80 r/min-120 r/min, and an ambient relative humidity of 40% RH-60% RH.

5. The preparation method for the recyclable electret filtering membrane according to claim 1, wherein the recyclable electret filtering membrane further comprises further fluorination improvement; and a substance used for the fluorination improvement comprises one or more of perfluorooctyltriethoxysilane and perfluorodecyltriethoxysilane.

6. The preparation method for the recyclable electret filtering membrane according to claim 5, wherein the fluorination improvement specifically comprises: performing surface fluorination by dip coating; and a dip-coated surface fluorination solution has a mass fraction of 2%-5%.

7. A recyclable electret filtering membrane prepared by the preparation method according to claim 1, wherein the recyclable electret filtering membrane is an electrostatic spinning fiber membrane with a surface containing C—F bond.

8. The recyclable electret filtering membrane according to claim 7, wherein the recyclable electret filtering membrane has a fiber diameter of 1 μm-15 μm, a gram weight of 50 g/m²-150 g/m², a water contact angle of 140°-160°, an initial surface potential of −600V to −950 V, and an initial pressure drop of 60 Pa-150 Pa; and after cleaning and regeneration, a charge recovery rate is 90%-125%, a dust removal rate is 90%-100%, and a filtering efficiency for PM_{2.5} is equal to or greater than 94%.

9. A cleaning and charge regeneration method for the recyclable electret filtering membrane according to claim 7, comprising following steps: subjecting a surface of the recyclable electret filtering membrane to water drop rolling cleaning and friction electrification after dust holding, and then performing drying to realize charge regeneration and reuse.

10. The cleaning and charge regeneration method for the recyclable electret filtering membrane according to claim 9, wherein a method for the water drop rolling cleaning and friction electrification is as follows: an inclination angle of the recyclable electret filtering membrane is 30°-60°; water drops drop continuously and roll down from the surface of the filtering membrane, a volume of a single water drop is 10 μL-100 μL, a dropping height is 3 cm-10 cm, a dropping time interval is 1 s-10 s, and a total dropping time is 5 min-15 min; and the drying is performed at a temperature of 40° C.-60° C.

11. A recyclable electret filtering membrane prepared by the preparation method according to claim 2, wherein the recyclable electret filtering membrane is an electrostatic spinning fiber membrane with a surface containing C—F bond.

12. A cleaning and charge regeneration method for the recyclable electret filtering membrane according to claim 11, comprising following steps: subjecting a surface of the recyclable electret filtering membrane to water drop rolling cleaning and friction electrification after dust holding, and then performing drying to realize charge regeneration and reuse.

13. A recyclable electret filtering membrane prepared by the preparation method according to claim 3, wherein the recyclable electret filtering membrane is an electrostatic spinning fiber membrane with a surface containing C—F bond.

14. A recyclable electret filtering membrane prepared by the preparation method according to claim 13, wherein the recyclable electret filtering membrane is an electrostatic spinning fiber membrane with a surface containing C—F bond.

15. A recyclable electret filtering membrane prepared by the preparation method according to claim 4, wherein the recyclable electret filtering membrane is an electrostatic spinning fiber membrane with a surface containing C—F bond.

16. A recyclable electret filtering membrane prepared by the preparation method according to claim 15, wherein the recyclable electret filtering membrane is an electrostatic spinning fiber membrane with a surface containing C—F bond.

17. A recyclable electret filtering membrane prepared by the preparation method according to claim 5, wherein the recyclable electret filtering membrane is an electrostatic spinning fiber membrane with a surface containing C—F bond.

18. A recyclable electret filtering membrane prepared by the preparation method according to claim 17, wherein the recyclable electret filtering membrane is an electrostatic spinning fiber membrane with a surface containing C—F bond.

19. A recyclable electret filtering membrane prepared by the preparation method according to claim 6, wherein the recyclable electret filtering membrane is an electrostatic spinning fiber membrane with a surface containing C—F bond.

20. A recyclable electret filtering membrane prepared by the preparation method according to claim 19, wherein the recyclable electret filtering membrane is an electrostatic spinning fiber membrane with a surface containing C—F bond.
